(19) United States
(12) Patent Application Publication
(10) Pub. No.: US 2024/0300852 A1
(43) Pub. Date: Sep. 12, 2024

(54) GLASS-CERAMIC AND ELECTRONIC COMPONENT

(71) Applicant: Murata Manufacturing Co., Ltd., Nagaokakyo-shi, Kyoto-fu (JP)

(72) Inventors: Jun URAKAWA, Nagaokakyo-shi (JP); Yasutaka SUGIMOTO, Nagaokakyo-shi (JP); Taichi WATANABE, Nagaokakyo-shi (JP)

(21) Appl. No.: 18/665,639

(22) Filed: May 16, 2024

Related U.S. Application Data
(63) Continuation of application No. PCT/JP2022/041561, filed on Nov. 8, 2022.

(30) Foreign Application Priority Data
Nov. 25, 2021 (JP) 2021-190951

(51) Int. Cl. C03C 10/00

(52) U.S. Cl. CPC C03C 10/0027; C03C 10/0054

(57) ABSTRACT

A glass-ceramic containing: glass containing Si, B, Al, and Zn; crystal phases of SiO₂, ZnAl₂O₄, and Al₂O₃; and an aggregate, wherein, with respect to a weight of the glass-ceramic, a content of the glass is 45% by weight to 80% by weight and, as the aggregate, a content of SiO₂ is 20% by weight to 50% by weight, a content of Al₂O₃ is 20% by weight or less, and a content of ZnO is 10% by weight or less.

### CROSS REFERENCE TO RELATED APPLICATIONS

The present application is a continuation of International application No. PCT/JP2022/041561, filed Nov. 8, 2022, which claims priority to Japanese Patent Application No. 2021-190951, filed Nov. 25, 2021, the entire contents of each of which are incorporated herein by reference.

### TECHNICAL FIELD

The present description relates to a glass-ceramic and an electronic component.

### BACKGROUND ART

Glass-ceramic materials that can be fired at low temperatures are known as ceramic materials for ceramic multilayer wiring boards.

For example, Patent Literature 1 discloses a glass composition for low-temperature fired board having a basic composition of RO—Al₂O₃—B₂O₃—SiO₂ (where RO is one or two or more selected from the group consisting of MgO, CaO, SrO, BaO, and ZnO), in which RO and Al₂O₃ are both contained in a range of 1 to 25 mol % and the mol % ratio of SiO₂/B₂O₃ is 1.3 or less, and a glass-ceramic containing an aggregate in the glass composition for low-temperature fired board.
Patent Literature 1: JP 2004-26529 A

### SUMMARY OF THE DESCRIPTION

The glass-ceramic described in Patent Literature 1 can achieve an excellent dielectric loss of 20×10⁻⁴ or less at 3 GHz.

However, the glass composition for low-temperature fired board described in Patent Literature 1 has a SiO₂/B₂O₃ mol % ratio of 1.3 or less and a high B (boron) content rate. Glass having such a high boron composition can have a low dielectric loss but has the problem that the boron content is unstable. Specifically, problems arise in that boron is eluted into the solvent during mixing and grinding or boron is volatilized during firing. When the boron content decreases by elution or volatilization, the viscosity of the glass during firing decreases, causing insufficient sintering. Glass having a decreased boron content by elution or volatilization is chemically unstable and has low moisture resistance and low plating solution resistance, and this may lead to deterioration in quality.

The glass-ceramic described in Patent Literature 1 has a low coefficient of thermal expansion of less than 6 ppm/K and has a large difference in coefficient of thermal expansion from other dielectrics and mounting boards, and this is likely to cause quality failure.

The present description is intended to solve the above-mentioned problems, and an object thereof is to provide a glass-ceramic having a low relative dielectric constant and a low dielectric loss and a high coefficient of thermal expansion.

An embodiment of the glass-ceramic of the present description is a glass-ceramic containing: glass containing Si, B, Al, and Zn; and an aggregate, wherein, with respect to a weight of the glass-ceramic, a content of the glass is 45% by weight to 80% by weight and, as the aggregate, a content of SiO₂ is 20% by weight to 50% by weight, a content of Al₂O₃ is 20% by weight or less, and a content of ZnO is 10% by weight or less, and wherein the glass ceramic comprises crystal phases of SiO₂, ZnAl₂O₄, and Al₂O₃.

Another embodiment of the glass-ceramic of the present description is a glass-ceramic containing: Si, B, Al and Zn, in which a SiO₂ content is 52.00% by weight to 71.58% by weight, a B₂O₃ content is 6.30% by weight to 21.00% by weight, an Al₂O₃ content is 7.63% by weight to 22.00% by weight, a ZnO content is 5.04% by weight to 17.00% by weight, and a Li₂O content is 0.55% by weight or less, and wherein the glass ceramic comprises crystal phases of SiO₂, ZnAl₂O₄, and Al₂O₃.

The electronic component of the present description includes a glass-ceramic layer that is a sintered body of the glass-ceramic of the present description.

According to the present description, it is possible to provide a glass-ceramic having a low relative dielectric constant and a low dielectric loss and a high coefficient of thermal expansion.

### BRIEF DESCRIPTION OF THE DRAWINGS

FIG. 1 is a cross-sectional view schematically illustrating an example of a laminated ceramic electronic component as an electronic component of the present description.

FIG. 2 is a schematic cross-sectional view illustrating a laminated green sheet (in unfired state) fabricated in the manufacturing process of the laminated ceramic electronic component illustrated in FIG. 1.

### DESCRIPTION OF THE PREFERRED EMBODIMENTS

Hereinafter, the glass-ceramic and electronic component of the present description will be described. The present description is not limited to the following configuration, and may be modified as appropriate without departing from the gist of the present description. The present description also includes combinations of a plurality of individual preferred configurations described below.

The glass-ceramic of the present description is a low temperature co-fired ceramic (LTCC) material. As used herein, “low-temperature co-fired ceramic material” means a glass-ceramic material that can be sintered at a firing temperature of 1000° C. or less.

An embodiment of the glass-ceramic of the present description is a glass-ceramic containing: glass containing Si, B, Al, and Zn and an aggregate, wherein, with respect to a weight of the glass-ceramic, a content of the glass is 45% by weight to 80% by weight and, as the aggregate, a content of SiO₂ is 20% by weight to 50% by weight, a content of Al₂O₃ is 20% by weight or less, and a content of ZnO is 10% by weight or less.

The glass used in the present description contains Si, B, Al and Zn.

As the glass, glass is preferable in which the content of SiO₂ is 15% by weight to 65% by weight, the content of B₂O₃ is 11% by weight to 30% by weight, the weight ratio (SiO₂/B₂O₃) of SiO₂ to B₂O₃ is 1.21 or more, and the weight ratio (Al₂O₃/ZnO) of Al₂O₃ to ZnO is 0.75 to 1.64.

The content of SiO₂ contained in the glass is preferably 15% by weight to 65% by weight, more preferably 45% by weight to 60% by weight. In a case where the content of SiO₂ is 15% by weight to 65% by weight, it contributes to a decrease in relative dielectric constant when a glass-ceramic containing the glass is sintered. As a result, the stray capacitance and the like associated with the increase in frequency of electrical signals are suppressed.

When the content of SiO₂ in the glass exceeds 65% by weight, a problem arises in that it is difficult to perform sintering at 1000° C. or less or the crystallization temperature increases and ZnAl₂O₄ crystals are less likely to precipitate. In particular, when the crystallization temperature exceeds 1000° C., crystals do not precipitate during firing of the glass-ceramic and the Q value of the glass-ceramic is likely to decrease. Meanwhile, when the content of SiO₂ contained in the glass is less than 15% by weight, the viscosity decreases too much and it is difficult to perform vitrification.

B₂O₃ in the glass contributes to the decrease in glass viscosity. Therefore, a dense sintered body of the glass-ceramic is obtained.

The content of B₂O₃ contained in the glass is preferably 11% by weight to 30% by weight, more preferably 15% by weight to 30% by weight.

The weight ratio (SiO₂/B₂O₃) of SiO₂ to B₂O₃ is preferably 1.21 or more. When the weight ratio is in this range, the proportion of B₂O₃ in the entire glass is small. Hence, elution and volatilization of boron from the glass are less likely to occur, and problems such as insufficient sintering and a decrease in plating solution resistance are less likely to arise.

The weight ratio (SiO₂/B₂O₃) of SiO₂ to B₂O₃ is preferably 4 or less.

Al₂O₃ in the glass contributes to the improvement in chemical stability of the glass. ZnO in the glass forms a crystal phase of ZnAl₂O₄ together with Al₂O₃.

When the glass contains Al and Zn, crystals of ZnAl₂O₄, which contribute to the decrease in loss, precipitate in the glass.

The weight ratio (Al₂O₃/ZnO) of Al₂O₃ to ZnO is preferably 0.75 to 1.64. When the weight ratio is in this range, the content of ZnAl₂O₄ in the glass is in a preferable range.

When the weight ratio (Al₂O₃/ZnO) of Al₂O₃ to ZnO is less than 0.75, the amount of ZnO is too large and the Q value, which is the reciprocal of dielectric loss, decreases. Meanwhile, when the weight ratio (Al₂O₃/ZnO) of Al₂O₃ to ZnO exceeds 1.64, the amount of Al₂O₃ is too large, the viscosity of the glass increases, and it may be impossible to obtain a dense sintered body.

In the glass-ceramic of the present description, it is preferable that the glass is crystallized glass and contains ZnAl₂O₄, which is a crystal phase precipitated from the glass.

As ZnAl₂O₄ precipitates during firing of the glass-ceramic, a glass-ceramic having a low dielectric loss and a high Q value is obtained. For this reason, the crystallization temperature of the glass is preferably equal to or less than the temperature at which the glass-ceramic is fired. Specifically, the crystallization temperature of the glass is preferably 1000° C. or less. When the crystallization temperature of the glass is 1000° C. or less, the Q value can be increased.

In the glass-ceramic of the present description, the glass may contain Li₂O as a sub-component. The content of Li₂O is preferably 1.0% by weight or less. Li₂O in the glass contributes to the decrease in glass viscosity. When Li₂O is contained in the glass, the sinterability of the glass-ceramic is improved.

The glass-ceramic of the present description contains SiO₂ as an aggregate at 20% by weight to 50% by weight.

SiO₂ as an aggregate is preferably quartz. Quartz has a low relative dielectric constant, and the relative dielectric constant of the glass-ceramic can be lowered when quartz is used as an aggregate. Quartz contributes to the increase in coefficient of thermal expansion when the glass-ceramic is sintered. Since the coefficient of thermal expansion of glass is approximately 6 ppm/K while the coefficient of thermal expansion of quartz is approximately 15 ppm/K, a high coefficient of thermal expansion is obtained when the glass-ceramic is sintered by containing quartz in the glass-ceramic. Therefore, the difference in thermal expansion with metal materials such as Ag and Cu used as electrodes can be decreased, and the thermal stress generated during the cooling process after sintering decreases, and internal flaws such as cracks around the electrodes are less likely to be generated.

Reliability during mounting on a mounting board (for example, a resin board) is enhanced. However, as the amount of quartz added increases, the Q value tends to decrease slightly.

When the content of SiO₂ as an aggregate is 20% by weight to 50% by weight, the coefficient of thermal expansion of the glass-ceramic can be increased to approach the coefficient of thermal expansion of a conductive layer formed of copper, silver, or the like. When the content of SiO₂ as an aggregate is less than 20% by weight, the coefficient of thermal expansion of the glass-ceramic is too low in some cases. When the content of SiO₂ as an aggregate exceeds 50% by weight, the coefficient of thermal expansion of the glass-ceramic is too high in some cases.

Amorphous silica or silica glass may be used as SiO₂ of an aggregate. Since amorphous silica and silica glass have a still lower relative dielectric constant than quartz, the relative dielectric constant of the glass-ceramic can be further lowered. Two or more of quartz, amorphous silica, or silica glass may be used.

The glass-ceramic of the present description contains Al₂O₃ as an aggregate at 20% by weight or less.

The glass-ceramic of the present description may not contain Al₂O₃ as an aggregate.

Al₂O₃ as an aggregate contributes to the decrease in dielectric loss and the increase in mechanical strength when the glass-ceramic is sintered. Specifically, the Q value increases by the addition of Al₂O₃. The flexural strength increases, and a glass-ceramic having a flexural strength exceeding 150 MPa can be obtained by using Al₂O₃ as an aggregate. Since the flexural strength of the glass-ceramic affects the strength when the glass-ceramic is used as an electronic component, and it is more preferable as the flexural strength is higher. The flexural strength is particularly preferably 150 MPa or more.

The reason for the improvement in flexural strength is considered to be that the precipitation of ZnAl₂O₄ from the glass is promoted by the addition of Al₂O₃ as an aggregate. The reason is also considered to be that Al₂O₃, which has a high Q value and high strength, is contained as a crystal phase.

When Al₂O₃ is contained as an aggregate, the precipitation of cristobalite crystals when the glass-ceramic is sintered can be prevented. Since cristobalite crystal is a type of SiO₂ crystal but undergoes a phase transition at about 280° C., when cristobalite crystals precipitate during the sintering process of glass-ceramic, the volume changes significantly in a high-temperature environment and the reliability decreases. From this point of view as well, it is preferable that the glass-ceramic does not contain cristobalite crystals. Here, “not containing cristobalite crystals” means that the content of cristobalite crystals is equal to or less than the detection limit. The presence or absence of cristobalite crystal precipitation is examined by crystal structure analysis such as X-ray diffraction (XRD).

In order to exert the effects obtained by containing Al₂O₃ as an aggregate, the amount of Al₂O₃ added is preferably 1% by weight or more. However, the relative dielectric constant of the glass-ceramic increases by the addition of Al₂O₃. For this reason, the amount of Al₂O₃ added as an aggregate is preferably 10% by weight or less. Further, when the amount of Al₂O₃ added as an aggregate exceeds 20% by weight, sintering of the glass-ceramic is inhibited.

The glass-ceramic of the present description contains ZnO as an aggregate at 10% by weight or less.

The glass-ceramic of the present description may not contain ZnO as an aggregate.

When ZnO as an aggregate is contained, the sinterability can be improved. The volatile component of ZnO in the glass can be supplemented with ZnO as an aggregate.

In order to exert the effects obtained by containing ZnO as an aggregate, the amount of ZnO added is preferably 1.0% by weight or more, more preferably 2.5% by weight or more. However, when the amount of ZnO added as an aggregate exceeds 10% by weight, the relative dielectric constant of the glass-ceramic increases. Zn₂SiO₄ (willemite) is generated during firing by the addition of ZnO in some cases.

The glass-ceramic of the present description preferably contains SiO₂, ZnAl₂O₄, and Al₂O₃ as crystal phases. Since SiO₂, ZnAl₂O₄, and Al₂O₃ as crystal phases are contained in the fired glass-ceramic, the glass-ceramic has a low relative dielectric constant, a low dielectric loss, a high Q value, a high coefficient of thermal expansion, and a high flexural strength. Quartz is preferable as the SiO₂ crystal phase, and gahnite is preferable as the ZnAl₂O₄ crystal phase.

The presence of these crystal phases can be examined by crystal structure analysis such as X-ray diffraction (XRD).

The relative dielectric constant of the glass-ceramic of the present description is preferably 5.0 or less, more preferably 4.5 or less, still more preferably 4.3 or less.

The relative dielectric constant of the glass-ceramic is determined as the value measured at 6 GHz or 30 GHz.

The relative dielectric constant at 6 GHz can be measured by the perturbation method.

The relative dielectric constant at 30 GHz can be measured by the TE₀₁₁ mode resonant cavity method in conformity with JIS R 1641.

According to the present description, it is possible to provide a glass-ceramic having a low boron content rate, a low relative dielectric constant and a low dielectric loss, a high Q value, and a high coefficient of thermal expansion. Furthermore, by containing Al₂O₃ as an aggregate, the Q value can be increased and the flexural strength can be improved.

In the glass-ceramic of the present description, the glass and aggregate can be distinguished or separated from each other by a method for analyzing electron diffraction patterns using a scanning electron microscope (SEM) or a transmission electron microscope (TEM) or a method for eluting the glass portion with hydrogen fluoride or the like.

By performing elemental analysis such as wavelength dispersive X-ray analysis (WDX), energy dispersive X-ray analysis (EDX), and inductively coupled plasma emission spectroscopy (ICP) on the distinguished or separated glass and aggregate, the compositions of the glass and aggregate can be determined, respectively. By the method, the content of SiO₂ as glass and the content of SiO₂ as an aggregate can be each measured. The same applies to the other elements.

Another embodiment of the glass-ceramic of the present description is a glass-ceramic containing Si, B, Al and Zn, in which the SiO₂ content is 52.00% by weight to 71.58% by weight, the B₂O₃ content is 6.30% by weight to 21.00% by weight, the Al₂O₃ content is 7.63% by weight to 22.00% by weight, the ZnO content is 5.04% by weight to 17.00% by weight, and the Li₂O content is 0.55% by weight or less. The glass-ceramic of this embodiment also preferably contains SiO₂, ZnAl₂O₄, and Al₂O₃ as crystal phases.

The SiO₂ content is preferably 60% by weight or more, the B₂O₃ content is preferably 15% by weight or less, the Al₂O₃ content is preferably 15% by weight or less, and the ZnO content is preferably 12% by weight or less.

Another embodiment of the glass-ceramic of the present description corresponds to a part of one embodiment of the glass-ceramic in which the contents of Si, B, Al, and Zn are regulated without distinguishing the glass and aggregate from each other. Hence, another embodiment of the glass-ceramic of the present description exhibits the effects exerted by one embodiment of the glass-ceramic of the present description.

### [Electronic Component]

The electronic component of the present description includes a glass-ceramic layer that is a sintered body of the glass-ceramic of the present description.

Examples of the electronic component of the present description include a laminated body including a plurality of glass-ceramic layers that are sintered bodies of the glass-ceramic of the present description or a laminated ceramic electronic component including a laminated ceramic board fabricated using the laminated body, and a chip component mounted on the ceramic board.

The electronic component of the present description includes a glass-ceramic layer that is a sintered body of the glass-ceramic of the present description, and thus has a low relative dielectric constant or a low dielectric loss.

The laminated body including a plurality of glass-ceramic layers that are sintered bodies of the glass-ceramic of the present description can be used, for example, in ceramic multilayer boards for communications and laminated dielectric filters.

The electronic component of the present description has a low relative dielectric constant, a low dielectric loss, and a high Q value, and is thus particularly suitable as an electronic component used in the millimeter wave band.

The coefficient of thermal expansion of the glass-ceramic layer is preferably 6 ppm/K or more.

The relative dielectric constant of the glass-ceramic layer is preferably 4.5 or less.

The Q value of the glass-ceramic layer is preferably 800 or more.

The flexural strength of the glass-ceramic layer is preferably 150 MPa or more.

It is preferable that the electronic component of the present description includes an electrode formed of a metal including Cu, and a content of Cu in the glass-ceramic layer is 0.5% by weight or less in terms of CuO.

In a case where Cu is used as an electrode, diffusion of Cu from the electrode into the glass-ceramic occurs. Cu diffused from the electrode may change the sinterability of the glass-ceramic around the electrode, and this may cause defects such as voids. By adding a small amount of CuO as an aggregate to the glass-ceramic, such defects can be prevented. Cu may be added in an amount exceeding 0.5% by weight in terms of CuO, but in that case, Cu is likely to precipitate in the glass-ceramic, so there is a risk of short-circuiting between electrodes when the glass-ceramic is used as an electronic component.

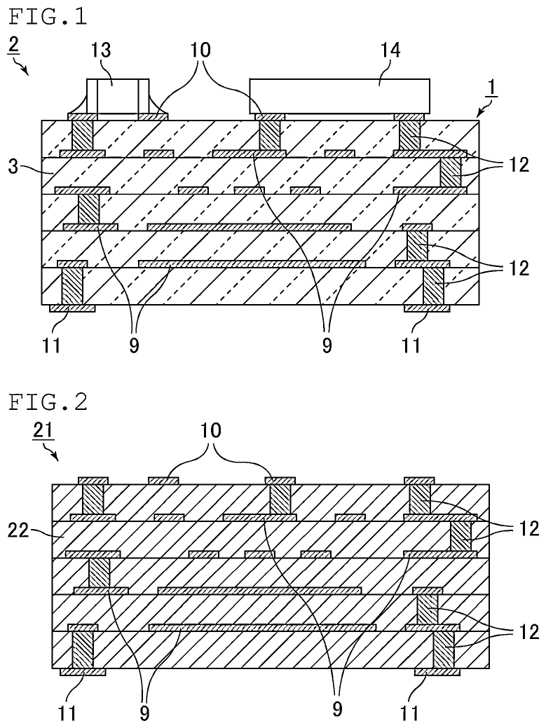

FIG. 1 is a cross-sectional view schematically illustrating an example of a laminated ceramic electronic component as the electronic component of the present description. As illustrated in FIG. 1, an electronic component 2 includes a laminated body 1 formed by laminating a plurality of glass-ceramic layers 3 (five layers in FIG. 1), and chip components 13 and 14 mounted on the laminated body 1. The laminated body 1 is also a laminated ceramic board.

The glass-ceramic layer 3 is a sintered body of the glass-ceramic of the present description. Hence, the laminated body 1 formed by laminating a plurality of glass-ceramic layers 3 and the electronic components 2, which include a laminated ceramic board fabricated using the laminated body 1 and the chip components 13 and 14 mounted on the laminated ceramic board (laminated body 1), are all the electronic component of the present description. The compositions of the plurality of glass-ceramic layers 3 may be the same as or different from each other, but are preferably the same as each other.

The laminated body 1 may further include a conductor layer. The conductor layer constitutes, for example, a passive element such as a capacitor or an inductor, or constitutes a connection line responsible for electrical connection between elements. Such a conductor layer includes conductor layers 9, 10, and 11 and a via hole conductor layer 12 as illustrated in FIG. 1.

The conductor layers 9, 10, and 11 and the via hole conductor layer 12 preferably contain Ag or Cu as a main ingredient. By using such a low resistant metal, signal propagation delays associated with the increase in frequency of electrical signals are prevented from occurring. Since the glass-ceramic of the present description is used as the constituent material of the glass-ceramic layer 3, co-firing with Ag and Cu is possible.

The conductor layer 9 is disposed inside the laminated body 1. Specifically, the conductor layer 9 is disposed at the interface between the glass-ceramic layers 3.

The conductor layer 10 is disposed on one main surface of the laminated body 1.

The conductor layer 11 is disposed on the other main surface of the laminated body 1.

The via hole conductor layer 12 is disposed to penetrate the glass-ceramic layer 3, and has a role of electrically connecting the conductor layers 9 of different levels, electrically connecting the conductor layers 9 and 10, or electrically connecting the conductor layers 9 and 11.

The laminated body 1 is manufactured, for example, as follows.

### (A) Preparation of Glass

Glass is prepared by mixing SiO₂, B₂O₃, Al₂O₃, and ZnO and sub-components (Li₂O and the like) added if necessary so that the content of SiO₂ is 15% by weight to 65% by weight, the content of B₂O₃ is 11% by weight to 30% by weight, the weight ratio (SiO₂/B₂O₃) of SiO₂ to B₂O₃ is 1.21 or more, and the weight ratio (Al₂O₃/ZnO) of Al₂O₃ to ZnO is 0.75 to 1.64.

### (B) Preparation of Glass-Ceramic

The glass-ceramic of the present description is prepared by mixing the glass with SiO₂, Al₂O₃, and ZnO as aggregates and other aggregates (CuO and the like) added if necessary.

### (C) Fabrication of Green Sheet

The glass-ceramic of the present description is mixed with a binder, a plasticizer, and the like to prepare a ceramic slurry. Next, the ceramic slurry is shaped on a base film (for example, a polyethylene terephthalate (PET) film) and then dried to fabricate a green sheet.

### (D) Fabrication of Laminated Green Sheet

A laminated green sheet (in unfired state) is fabricated by laminating the green sheets. FIG. 2 is a schematic cross-sectional view illustrating a laminated green sheet (in unfired state) fabricated in the manufacturing process of the laminated ceramic electronic component illustrated in FIG. 1. As illustrated in FIG. 2, a laminated green sheet 21 is formed by laminating a plurality of green sheets 22 (five sheets in FIG. 2). The green sheet 22 becomes the glass-ceramic layer 3 after firing. Conductor layers including the conductor layers 9, 10, and 11 and the via hole conductor layer 12 may be formed on or in the laminated green sheet 21. The conductor layer can be formed using a conductive paste containing Ag or Cu by a screen printing method, a photolithography method, or the like.

### (E) Firing of Laminated Green Sheet

The laminated green sheet 21 is fired. As a result, the laminated body 1 as illustrated in FIG. 1 is obtained.

The firing temperature of the laminated green sheet 21 is not particularly limited as long as it is a temperature at which the glass-ceramic of the present description constituting the green sheet 22 can be sintered, and may be, for example, 1000° C. or less.

The firing atmosphere of the laminated green sheet 21 is not particularly limited, but is preferably an air atmosphere in a case where a material, which is hardly oxidized, such as Ag is used for the conductor layers 9, 10, and 11 and the via hole conductor layer 12, and is preferably a low oxygen atmosphere such as a nitrogen atmosphere in a case where a material, which is easily oxidized, such as Cu is used. The firing atmosphere of the laminated green sheet 21 may be a reducing atmosphere.

The laminated green sheet 21 may be fired in a state of being sandwiched between constraining green sheets. The constraining green sheet contains as a main component an inorganic material (for example, Al₂O₃) that is not substantially sintered at the sintering temperature of the glass-ceramic of the present description constituting the green sheet 22. Therefore, the constraining green sheet does not shrink when the laminated green sheet 21 is fired, and acts to suppress shrinkage of the laminated green sheet 21 in the main surface direction. As a result, the dimensional accuracy of the obtained laminated body 1 (particularly the conductor layers 9, 10, and 11 and the via hole conductor layer 12) increases.

The chip components 13 and 14 may be mounted on the laminated body 1 in a state of being electrically connected to the conductor layer 10. The electronic component 2 including the laminated body 1 is thus configured.

Examples of the chip components 13 and 14 include LC filters, capacitors, and inductors.

The electronic component 2 may be mounted on a mounting board (for example, a motherboard) so as to be electrically connected via the conductor layer 11.

### EXAMPLES

Hereinafter, Examples that more specifically disclose the glass-ceramic and laminated ceramic electronic component of the present description will be described. The present description is not limited only to these Examples.

### (A) Preparation of Glass

Glasses G1 to G8 (all in powder form) having the compositions presented in Table 1 were produced by the following method. First, glass raw material powders were mixed, placed in a Pt—Rh crucible, and melted at 1650° C. in an air atmosphere for 6 hours or more. Thereafter, the obtained melt was rapidly cooled to produce cullet. The cullet was coarsely ground, then placed in a container together with an organic solvent and PSZ balls (diameter: 5 mm), and mixed using a ball mill. By adjusting the grinding time during mixing using a ball mill, a glass powder having a median particle size of 1.5 μm was obtained. Here, the “median particle size” means the median particle size D50 measured by the laser diffraction/scattering method.

### [Measurement of Glass Crystallization Temperature]

The measurement was performed on each glass in the temperature range from room temperature to 1000° C. using a differential scanning calorimeter DSC3300SA (manufactured by NETZSCH), and the temperature at the exothermic peak was taken as the crystallization temperature. The results are presented in Table 1.

TABLE 1

| | | | | | | | | Glass |
|---|---|---|---|---|---|---|---|---|
| | | | | | | SiO₂/B₂O₃ | Al₂O₃/ZnO | crystallization |
| | SiO₂ | B₂O₃ | Al₂O₃ | ZnO | Li₂O | weight | weight | temperature |
| Glass No. | [wt %] | [wt %] | [wt %] | [wt %] | [wt %] | ratio | ratio | [° C.] |
| G1 | 59.40 | 18.80 | 10.90 | 10.90 | — | 3.16 | 1.00 | 845 |
| G2 | 59.40 | 18.60 | 10.90 | 10.90 | 0.20 | 3.19 | 1.00 | 849 |
| G3 | 45.00 | 15.00 | 20.00 | 20.00 | — | 3.00 | 1.00 | 876 |
| G4 | 45.00 | 14.00 | 20.00 | 20.00 | 1.00 | 3.21 | 1.00 | 885 |
| G5 | 50.00 | 30.00 | 10.30 | 9.70 | — | 1.67 | 1.06 | 789 |
| G6 | 50.00 | 15.00 | 17.50 | 17.50 | — | 3.33 | 1.00 | 881 |
| G7 | 50.00 | 15.00 | 19.50 | 15.50 | — | 3.33 | 1.26 | 872 |
| G8 | 65.00 | 20.00 | 7.80 | 7.20 | — | 3.25 | 1.08 | 951 |

### (B) Fabrication of Green Sheet

Next, the glass and aggregate were added to ethanol and mixed using a ball mill at the composition presented in Table 2, and a binder solution dissolved in an organic solvent and a plasticizer were further mixed to prepare a slurry. The slurry was shaped on a PET film using a doctor blade and dried at 40° C. to obtain a green sheet having a thickness of 25 microns.

Among the aggregates, SiO₂ is quartz having a median particle size of 1 μm, and Al₂O₃ is a particle having a median particle size of 0.5 μm.

### (C) Fabrication of Evaluation Sample and Evaluation

### (1) Relative Dielectric Constant and Q Value (Reciprocal of Dielectric Loss)

As samples to evaluate the relative dielectric constant and Q value (reciprocal of dielectric loss) of glass-ceramics, a green sheet was cut into a size of 78 mm×58 mm, 30 pieces of the green sheet cut were stacked, placed in a mold, and pressure-bonded using a press, and the laminated body was cut into a size of 50 mm×50 mm and then fired at 980° C. for 60 minutes in a reducing atmosphere.

The laminated bodies obtained by firing are listed in Table 2 as ceramics L1 to L29.

The ceramics L6, L7, L12, L13, and L21 marked with * in Table 2 are not laminated bodies fabricated using the glass-ceramics of the present description.

The thickness of the fired samples was measured, and the relative dielectric constant and Q value (reciprocal of dielectric loss) at 6 GHz were measured by the perturbation method. The following instruments were used to measure the relative dielectric constant and Q value. A relative dielectric constant of 5.0 or less and a Q value of 500 or more were each considered favorable.

### [Measuring Instruments and Measurement Conditions]

Network analyzer: 8757D manufactured by Keysight Technologies

Signal generator: Synthesized sweeper 83751 manufactured by Keysight Technologies

Resonator: Self-made jig (resonance frequency: 6 GHz)

Prior to the measurement, the network analyzer and signal generator were connected to measure cable loss. The resonator was calibrated using a standard board (made of quartz, dielectric constant: 3.73, Q value: 4545@6 GHz, thickness: 0.636 mm).

### (2) Coefficient of Thermal Expansion α

For each of the ceramics L1 to L29, the coefficient of thermal expansion α was determined in the temperature range from room temperature to 600° C. using Dilato meter TD5000SE (manufactured by NETZSCH). A coefficient of thermal expansion G of 6.0 ppm/K or more was considered favorable.

### (3) Flexural Strength

For each of the ceramics L1 to L29, a three-point bending test was conducted in conformity with JIS R1601 using Autograph AGS-5kNX manufactured by Shimadzu Corporation.

### (4) Measurement of Crystal Phase

For each of the ceramics L1 to L29, the fired samples were ground into powder and subjected to the measurement by X-ray diffraction (XRD). The symbols of the XRD crystal phases presented in Table 2 are Q: SiO₂ (quartz), G: ZnALl₂O₄ (gahnite), A: Al₂₃, and W: Zn₂SiO₄ (willemite)

TABLE 2

| | | | | | | | Relative | | | | |
|---|---|---|---|---|---|---|---|---|---|---|---|
| | Glass | | Aggregate | | | | dielectric | | | Flexural | XRD |
| Ceramic | | Content | SiO₂ | Al₂O₃ | ZnO | CuO | constant | Q value | α | strength | crystal |
| No. | No. | [wt %] | [wt %] | [wt %] | [wt %] | [wt %] | [@ 6 GHZ] | [@ 6 GHZ] | [ppm/K] | [MPa] | phase |
| L1 | G1 | 80.0 | 20.0 | — | — | — | 4.20 | 1033 | 7.6 | 134 | Q, G |
| L2 | G1 | 70.0 | 30.0 | — | — | — | 4.18 | 769 | 8.0 | 128 | Q, G |
| L3 | G1 | 70.0 | 25.0 | 5.0 | — | — | 4.25 | 1148 | 8.7 | 166 | Q, G, A |
| L4 | G1 | 72.5 | 25.0 | — | 2.5 | — | 4.23 | 794 | 7.4 | 131 | Q, G, W |
| L5 | G1 | 67.5 | 25.0 | 5.0 | 2.5 | — | 4.30 | 952 | 9.3 | 165 | Q, G, A, W |
| L6* | G1 | 77.5 | 10.0 | 10.0 | 2.5 | — | 4.37 | 1171 | 5.8 | 171 | Q, G, A, W |
| L7* | G1 | 40.0 | 60.0 | — | — | — | Unsintered | — | — | — | — |
| L8 | G2 | 65.0 | 30.0 | 5.0 | — | — | 4.27 | 1075 | 8.7 | 170 | Q, G, A |
| L9 | G2 | 60.0 | 30.0 | 10.0 | — | — | 4.35 | 1003 | 8.8 | 188 | Q, G, A |
| L10 | G2 | 60.0 | 35.0 | 5.0 | — | — | 4.28 | 893 | 9.1 | 171 | Q, G, A |
| L11 | G2 | 57.5 | 30.0 | 10.0 | 2.5 | — | 4.38 | 962 | 8.9 | 179 | Q, G, A, W |
| L12* | G2 | 40.0 | 45.0 | 15.0 | — | — | Unsintered | — | — | — | — |
| L13* | G2 | 50.0 | 25.0 | 25.0 | — | — | Unsintered | — | — | — | — |
| L14 | G3 | 70.0 | 27.5 | 2.5 | — | — | 4.55 | 1050 | 7.9 | 158 | Q, G, A |
| L15 | G3 | 60.0 | 25.0 | 10.0 | 5.0 | — | 4.81 | 1120 | 8.7 | 178 | Q, G, A, W |
| L16 | G3 | 65.0 | 30.0 | — | 5.0 | — | 4.56 | 935 | 8.0 | 129 | Q, G, W |
| L17 | G4 | 55.0 | 35.0 | 10.0 | — | — | 4.74 | 780 | 8.2 | 176 | Q, G, A |
| L18 | G4 | 45.0 | 50.0 | 5.0 | — | — | 4.68 | 565 | 9.1 | 154 | Q, G, A |
| L19 | G4 | 50.0 | 30.0 | 10.0 | 10.0 | — | 4.91 | 571 | 7.8 | 177 | Q, G, A, W |
| L20 | G4 | 50.0 | 30.0 | 20.0 | — | — | 4.96 | 680 | 8.6 | 184 | Q, G, A |
| L21 | G4 | 50.0 | 25.0 | 10.0 | 15.0 | — | 5.09 | 450 | 7.3 | 163 | Q, G, A, W |
| L22 | G5 | 70.0 | 25.0 | 5.0 | — | — | 4.22 | 1227 | 8.2 | 155 | Q, G, A |
| L23 | G6 | 74.0 | 25.0 | 1.0 | — | — | 4.35 | 952 | 8.2 | 151 | Q, G, A |
| L24 | G6 | 70.0 | 25.0 | 5.0 | — | — | 4.39 | 1010 | 8.4 | 158 | Q, G, A |
| L25 | G6 | 67.5 | 25.0 | 5.0 | 2.5 | — | 4.41 | 962 | 8.1 | 155 | Q, G, A, W |
| L26 | G7 | 70.0 | 25.0 | 5.0 | — | — | 4.37 | 1083 | 8.5 | 160 | Q, G, A |
| L27 | G8 | 70.0 | 25.0 | 5.0 | — | — | 4.21 | 909 | 7.9 | 158 | Q, G, A |
| L28 | G2 | 59.9 | 30.0 | 10.0 | — | 0.1 | 4.36 | 1000 | 8.8 | 183 | Q, G, A |
| L29 | G2 | 57.0 | 30.0 | 10.0 | 2.5 | 0.5 | 4.39 | 990 | 8.8 | 177 | Q, G, A |

From the results in Table 2, it can be seen that the laminated bodies including glass-ceramic layers, which are sintered bodies of the glass-ceramics of the present description, have a low relative dielectric constant, a high Q value (low dielectric loss), and a high coefficient of thermal expansion. Also, the glass-ceramic is free of MgO, CaO, SrO, and BaO.

L6 had a low coefficient of thermal expansion α. The reason is considered to be that SiO₂ as an aggregate is contained at less than 20% by weight.

L7 was insufficiently sintered. The reason is considered to be that the glass content is less than 45% by weight and SiO₂ as an aggregate is contained at more than 50% by weight.

L12 was also insufficiently sintered, and the reason is considered to be that the glass content is less than 45% by weight.

L13 was also insufficiently sintered, and the reason is considered to be that Al₂O₃ as an aggregate is contained at more than 20% by weight.

L21 has a high relative dielectric constant and a low Q value. The reason is considered to be that ZnO as an aggregate is contained at more than 10% by weight.

L3, L5, L6, L8 to L11, L14, L15, and L17 to L29, which contained Al₂O₃ as an aggregate and were sintered, had a large flexural strength exceeding 150 MPa.

### (5) Measurement of Dielectric Properties in Millimeter Wave Band

For the ceramics L1, L3, L5, and L14, the relative dielectric constant and Q value (reciprocal of dielectric loss) in the millimeter wave band (30 GHz) were measured by the TE₀₁₁ mode resonant cavity method in conformity with JIS R 1641. The results are presented in Table 3.

TABLE 3

| | Resonance | Relative dielectric | |
|---|---|---|---|
| Ceramic | frequency f0 | constant | Q value |
| No. | [GHz] | [@ 30 GHz] | [@30 GHZ] |
| L1 | 30.9 | 4.16 | 938 |
| L3 | 30.9 | 4.19 | 1053 |
| L5 | 30.7 | 4.24 | 1002 |
| L14 | 30.5 | 4.49 | 997 |

From the results presented in Table 3, it can be seen that each glass-ceramic has a low relative dielectric constant and a high Q value at a frequency in the millimeter wave band (approximately 30 GHz) as well. In order to use the glass-ceramic as an electronic component for millimeter wave band, it is more preferable that the relative dielectric constant is 4.5 or less and the Q value is 800 or more. As described above, the glass-ceramic of the present description is a material suitable for electronic components for millimeter wave band.

In another embodiment of the glass-ceramic of the present description, the contents of Si, B, Al, and Zn are regulated without distinguishing the glass and aggregate from each other in one embodiment of the glass-ceramic, but the ratio of the respective elements in the glass-ceramic in Examples described above can be calculated from the glass composition presented in Table 1 and the glass-ceramic composition presented in Table 2.

Each element is expressed as an oxide. For example, the ceramic L3 contains the glass G1 at 70.0% by weight and SiO₂ at 25.0% by weight and Al₂O₃ at 5.0% by weight as aggregates. The amount of SiO₂ in the ceramic L3 is the sum of the amount contained in the glass G1 and the amount of aggregate, and is thus 70.0×59.4/100+25.0=66.58% by weight. Similarly, B₂O₃ is 70.0×18.8/100=13.16% by weight, Al₂O₃ is 70.0×10.9/100+5.0=12.63% by weight, and ZnO is 70.0×10.9/100=7.63% by weight. Table 4 presents examples of the ratios of the respective elements in several glass-ceramics calculated in this way.

TABLE 4

| | Ratio of elements in glass-ceramic | | | | |
|---|---|---|---|---|---|
| Ceramic | SiO₂ | B₂O₃ | Al₂O₃ | ZnO | Li₂O |
| No. | [wt %] | [wt %] | [wt %] | [wt %] | [wt %] |
| L1 | 67.52 | 15.04 | 8.72 | 8.72 | 0.00 |
| L2 | 71.58 | 13.16 | 7.63 | 7.63 | 0.00 |
| L3 | 66.58 | 13.16 | 12.63 | 7.63 | 0.00 |
| L5 | 65.09 | 12.69 | 12.36 | 9.86 | 0.00 |
| L8 | 68.61 | 12.09 | 12.09 | 7.08 | 0.13 |
| L14 | 59.00 | 10.50 | 16.50 | 14.00 | 0.00 |
| L15 | 52.00 | 9.00 | 22.00 | 17.00 | 0.00 |
| L17 | 59.75 | 7.70 | 21.00 | 11.00 | 0.55 |
| L18 | 70.25 | 6.30 | 14.00 | 9.00 | 0.45 |
| L22 | 60.00 | 21.00 | 12.21 | 6.79 | 0.00 |
| L27 | 70.50 | 14.00 | 10.46 | 5.04 | 0.00 |

As presented in Table 4, in another embodiment of the glass-ceramic of the present description, since the B₂O₃ content is low as a glass-ceramic, boron is less likely to be eluted from the fired glass-ceramic, and problems such as a decrease in plating solution resistance are less likely to arise. Since the content of SiO₂ is high and the contents of Al₂O₃ and ZnO are low in the glass-ceramic, the relative dielectric constant can be lowered. Also, the glass-ceramic is free of MgO, CaO, SrO, and BaO.

The glass-ceramic preferably contains SiO₂ at 60% by weight or more, B₂O₃ at 15% by weight or less, Al₂O₃ at 15% by weight or less, and ZnO at 12% by weight or less. This makes it possible to have a relative dielectric constant of 5 or less, further 4.5 or less.

### REFERENCE SIGNS LIST

laminated body
electronic component
glass-ceramic layer
9, 10, 11 conductor layer
12 via hole conductor layer
13, 14 chip component
21 laminated green sheet
22 green sheet

1. A glass-ceramic comprising:
glass containing Si, B, Al, and Zn; and
an aggregate,
wherein, with respect to a weight of the glass-ceramic,
a content of the glass is 45% by weight to 80% by weight, and
as the aggregate, a content of SiO₂ is 20% by weight to 50% by weight, a content of Al₂O₃ is 20% by weight or less, and a content of ZnO is 10% by weight or less, and
wherein the glass ceramic comprises crystal phases of SiO₂, ZnAl₂O₄, and Al₂O₃.

2. The glass-ceramic according to claim 1, wherein the content of Al₂O₃ is 1% by weight or more.

3. The glass-ceramic according to claim 1, wherein, in the glass,
a content of SiO₂ is 15% by weight to 65% by weight,
a content of B₂O₃ is 11% by weight to 30% by weight,
a weight ratio (SiO₂/B₂O₃) of SiO₂ to B₂O₃ is 1.21 or more, and
a weight ratio (Al₂O₃/ZnO) of Al₂O₃ to ZnO is 0.75 to 1.64.

4. The glass-ceramic according to claim 3, wherein the glass-ceramic is free of MgO, CaO, SrO, and BaO.

5. The glass-ceramic according to claim 1, wherein the weight ratio (SiO₂/B₂O₃) of SiO₂ to B₂O₃ is 4 or less.

6. The glass-ceramic according to claim 1, wherein the content of the ZnO is 1.0% by weight or more.

7. The glass-ceramic according to claim 1, wherein the glass is crystallized glass.

8. The glass-ceramic according to claim 1, wherein
the glass contains Li₂O as a sub-component, and
a content of Li₂O in the glass is 1.0% by weight or less.

9. The glass-ceramic according to claim 1, wherein a crystallization temperature of the glass is 1000° C. or less.

10. The glass-ceramic according to claim 1, wherein the glass-ceramic has a relative dielectric constant is 5 or less.

11. An electronic component comprising a glass-ceramic layer that is a sintered body of the glass-ceramic according to claim 1.

12. The electronic component according to claim 11, further comprising:
an electrode formed of a metal including Cu, wherein
a content of Cu in the glass-ceramic layer is 0.5% by weight or less in terms of CuO.

13. A glass-ceramic comprising:
Si, B, Al and Zn, wherein
a SiO₂ content is 52.00% by weight to 71.58% by weight,
a B₂O₃ content is 6.30% by weight to 21.00% by weight,
an Al₂O₃ content is 7.63% by weight to 22.00% by weight,
a ZnO content is 5.04% by weight to 17.00% by weight, and
a Li₂O content is 0.55% by weight or less, and
wherein the glass ceramic comprises crystal phases of SiO₂, ZnAl₂O₄, and Al₂O₃.

14. The glass-ceramic according to claim 13, wherein the glass-ceramic is free of MgO, CaO, SrO, and BaO.

15. The glass-ceramic according to claim 13, wherein
the SiO₂ content is 60% by weight to 71.58% by weight,
the B₂O₃ content is 6.30% by weight to 15% by weight, and
the ZnO content is 5.04% by weight to 12% by weight.

16. An electronic component comprising a glass-ceramic layer that is a sintered body of the glass-ceramic according to claim 13.

17. The electronic component according to claim 16, further comprising:
an electrode formed of a metal including Cu, wherein
a content of Cu in the glass-ceramic layer is 0.5% by weight or less in terms of CuO.
